(19) United States
(12) Patent Application Publication
(10) Pub. No.: US 2012/0188758 A1
(43) Pub. Date: Jul. 26, 2012

(54) LIGHTING DEVICE AND DISPLAY DEVICE

(75) Inventors: Kazuhiro Sugiyama, Osaka-shi (JP); Tsutomu Yamasaki, Osaka-shi (JP)

(73) Assignee: SHARP KABUSHIKI KAISHA, Osaka-shi, Osaka (JP)

(21) Appl. No.: 13/496,930

(22) PCT Filed: Jun. 2, 2010
(86) PCT No.: PCT/JP2010/059328

§ 371 Date: Mar. 19, 2012

(30) Foreign Application Priority Data
Oct. 2, 2009 (JP) 2009-230665

(51) Int. Cl. F21V 9/00

(52) U.S. Cl. 362/230

(57) ABSTRACT

A lighting device (3) having a plurality of light-emitting diodes (9a-9d) arranged in a rectilinear fashion, where the plurality of light-emitting diodes (9a-9d) are divided into a plurality of blocks (a-d) in the direction of arrangement thereof, and, in the plurality of blocks (a-d), the values of the current supplied to the light-emitting diodes (9b, 9c) contained in the central blocks in the direction of arrangement are made lower than the values of the current supplied to the light-emitting diodes (9a, 9d) contained in the blocks located on the outside of the central blocks.

### TECHNICAL FIELD

The present invention relates to a lighting device, in particular, to a lighting device equipped with a light-emitting diode as light source, as well as to a display device utilizing the lighting device.

### BACKGROUND ART

In recent years, liquid crystal display devices have been widely used in LCD TVs, monitors, cellular phones, and the like as flat panel displays that possess the advantages of being thinner, lighter, etc. than ordinary Braun tubes. Such liquid crystal display devices contain a lighting device (backlight) that radiates light and a liquid crystal panel that displays the desired images by acting as a shutter for the light emanating from the light source provided in the lighting device.

In addition, devices proposed as the above-described lighting devices include edge-lit or direct-lit devices, in which linear light source including cold cathode fluorescent lamp and hot cathode fluorescent lamp is arranged along the side or underneath the liquid crystal panel. However, due to the presence of mercury in the above-described cold cathode fluorescent lamp and the like, the recycling of discarded cold cathode fluorescent lamp has been problematic. Accordingly, lighting devices utilizing mercury-free light-emitting diode (LED) as light source have been developed and introduced for practical application.

Specifically, for example, as described in Patent Document 1 below, a conventional lighting device is provided with light-emitting diode, which serves as light source and is mounted on a film substrate, and a light guiding plate, which is used to radiate light from the light-emitting diode onto a liquid crystal panel. In addition, in this conventional lighting device, heat sink-shaped thermal dissipating member is arranged facing the film substrate, thereby enabling efficient release of heat generated in the light-emitting diode via the thermal dissipating member and preventing thermal effects on the space around the periphery of the light-emitting diode.

### CITATION LIST

### Patent Document

[Patent Document 1] JP 2006-235093A

### DISCLOSURE OF INVENTION

### Problem to be Solved by the Invention

However, in the above-described conventional lighting device, providing the thermal dissipating member behind the film substrate, on which the light-emitting diode is mounted, created a problem in that it was difficult to make the lighting device more compact. In particular, when the number of installed light-emitting diode was increased in the conventional lighting devices in order to meet demand for larger screen sizes and brighter liquid crystal panels, the number of installed thermal dissipating member increased and this made it impossible to achieve a reduction in the size of the lighting devices.

In view of the above-described problems, it is an object of the present invention to provide a lighting device, as well as a display device utilizing the lighting device, that is capable of achieving a reduction in size even if the number of installed light-emitting diode is increased.

### Means for Solving Problem

In order to attain the above-described object, a inventive lighting device having a plurality of light-emitting diodes arranged in a rectilinear fashion, wherein the plurality of light-emitting diodes is divided into a plurality of blocks in the direction of arrangement thereof, and in the plurality of blocks, the values of the electric current supplied to the light-emitting diodes contained in the central blocks in the direction of arrangement are made lower than the values of the electric current supplied to the light-emitting diodes contained in the blocks located on the outside of the central blocks.

In the lighting device configured as described above, the plurality of light-emitting diodes, which are rectilinearly arranged, are divided into the plurality of blocks in the direction of their arrangement. In addition, among the plurality of blocks, the values of the electric current supplied to the light-emitting diodes contained in the central blocks in the direction of arrangement are made lower than the values of the electric current supplied to the light-emitting diodes contained in blocks located on the outside of the central blocks. This makes it possible to achieve a uniform temperature distribution across the plurality of light-emitting diodes. As a result, in contradistinction to the above-described conventional example, the installation of thermal dissipating structure such as thermal dissipating member and the like can be forgone and a reduction in the size of the lighting device can be achieved even if the number of installed light-emitting diode is increased.

Further, in the above-described lighting device, in the plurality of blocks, it is preferable to set the values of the electric current supplied to the light-emitting diodes such that they become progressively lower from the external blocks towards the central blocks in the direction of arrangement.

In this case, a uniform temperature distribution can be obtained in a reliable manner even when there are provided three or more blocks with different supply current values.

In addition, in the above-described lighting device, the temperature distribution obtained in the plurality of light-emitting diodes when they are driven for illumination preferably is measured in advance and, in the plurality of blocks, the values of the electric current supplied to these light-emitting diodes preferably are established using the measured temperature distribution.

In this case, the values of the electric current supplied to the light-emitting diodes each of the plurality of blocks can be established in a more adequate manner and a uniform temperature distribution across the plurality of light-emitting diodes can be achieved in a more reliable manner.

In addition, in the above-described lighting device, it is preferable to provide the plurality of light-emitting diodes with an LED drive circuit supplying electric current to the plurality of block units.

In this case, the electric current can be supplied to the light-emitting diodes each of the plurality of blocks in an adequate manner.

In addition, in the above-described lighting device, it is preferable to use identical light-emitting diodes radiating white light as the plurality of light-emitting diodes.

In this case, control over how the luminaire is driven for illumination can be exercised more easily than when using light-emitting diodes of multiple types.

In addition, the inventive display device is characterized by using any of the above-described lighting devices.

A high-brightness and compact display device can be built easily because a display device configured as mentioned above makes use of lighting devices capable of achieving a reduction in size even when the number of installed light-emitting diode is increased.

### Effects of the Invention

The present invention makes it possible to provide a lighting device, as well as a display device utilizing the same, that is capable of achieving a reduction in size even if the number of installed light-emitting diodes is increased.

### BRIEF DESCRIPTION OF DRAWINGS

FIG. 1 is a diagram depicting a lighting device and a liquid crystal display device according to an embodiment of the present invention.

FIG. 2 is a diagram depicting the configuration of the liquid crystal panel illustrated in FIG. 1.

FIG. 3 is a plan view illustrating the configuration of the main components of the above-described lighting device.

FIG. 4 is a diagram depicting the configuration of the main components of the light-emitting diode illustrated in FIG. 1.

FIG. 5 is a circuit schematic illustrating a drive circuit used in the above-described light-emitting diode.

### DESCRIPTION OF THE INVENTION

Preferred embodiments of the lighting device and display device of the present invention will be explained below with reference to the drawings. It should be noted that in the description below the invention is discussed using examples, in which it is applied to a transmissive-type liquid crystal display device. Additionally, the dimensions of the components in the drawings are not a faithful representation of the actual dimensions of the components and the dimensional ratios, etc. of the components.

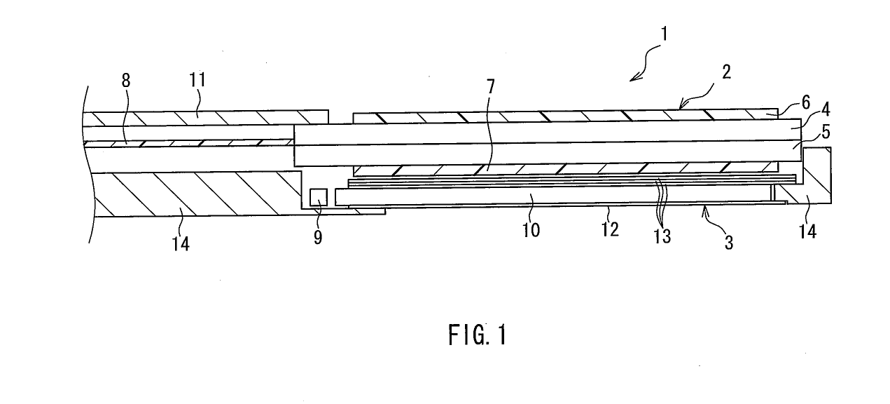

FIG. 1 is a diagram depicting a lighting device and a liquid crystal display device according to an embodiment of the present invention. In FIG. 1, a liquid crystal display device 1 according to the present embodiment is provided with a liquid crystal panel 2, which is disposed such that the upper side in FIG. 1 is the viewing side (display side), and a lighting device 3 of the present invention, which is arranged on the non-viewing side (lower side in FIG. 1) of the liquid crystal panel 2 and generates illumination light illuminating the liquid crystal panel 2.

The liquid crystal panel 2 includes a pair of substrates, i.e. a color filter substrate 4 and an active matrix substrate 5, and polarizing plates 6, 7, which are provided on the respective exterior surfaces of the color filter substrate 4 and active matrix substrate 5. A liquid crystal layer (not shown) is sandwiched between the color filter substrate 4 and the active-matrix substrate 5. In addition, pieces of plate-shaped transparent vitreous material or transparent synthetic resin, such as acrylic resin and the like, are used as the color filter substrate 4 and active-matrix substrate 5. Resin films made of TAC (triacetyl cellulose) or PVA (polyvinyl alcohol) and the like, which are used as the polarizing plates 6, 7, are adhered to the corresponding filter substrate 4 or active-matrix substrate 5 so as to cover at least the effective display areas of the display surface provided on the liquid crystal panel 2.

In addition, the active-matrix substrate 5 constitutes one substrate of the above-mentioned pair of substrates. Pixel electrodes, thin film transistors (TIT: Thin Film Transistor), and the like are formed on the active-matrix substrate 5 between the active-matrix substrate 5 and the above-mentioned liquid crystal layer in correspondence with the multiple pixels present on the display surface of the liquid crystal panel 2 (as discussed in more detail below). On the other hand, the color filter substrate 4 constitutes the other substrate of the above-mentioned pair of substrates. A color filter and counter electrodes (not shown) are formed on the color filter substrate 4 between the color filter substrate 4 and the above-mentioned liquid crystal layer.

In addition, in the liquid crystal panel 2, there is provided an FPC (Flexible Printed Circuit) 8 connected to a control device (not shown) controlling the actuation of the liquid crystal panel 2, and, by operating the above-described liquid crystal layer on a pixel-by-pixel basis, the display surface is driven on a pixel-by-pixel basis to display the desired images on the display surface.

It will be noted that the LCD mode and pixel structure of the liquid crystal panel 2 are arbitrary. In addition, the driving mode of the liquid crystal panel 2 is arbitrary. Namely, an arbitrary liquid crystal panel capable of displaying information can be used as the liquid crystal panel 2. Therefore, in FIG. 1, the detailed structure of the liquid crystal panel 2 is not shown and its description is also omitted.

The lighting device 3 includes a light-emitting diode 9 serving as a light source and a light guiding plate 10 disposed in a face-to-face relationship with the light-emitting diode 9. In addition, as described in detail below, in the lighting device 3, a plurality of light-emitting diodes 9 are arranged in a rectilinear manner in a direction perpendicular to the plane of the paper in FIG. 1. Further, in the lighting device 3, the light-emitting diodes 9 and light guiding plate 10 held by a bezel 14 of an L-shaped cross section, with the liquid crystal panel 2 disposed above the light guiding plate 10. In addition, a case 11 is placed on the color filter substrate 4. As a result, the lighting device 3 is attached to the liquid crystal panel 2 and integrated into a transmissive-type liquid crystal display device 1, in which illumination light from the lighting device 3 is incident on the liquid crystal panel 2.

A synthetic resin such as, for example, transparent acrylic resin is used for the light guiding plate 10, with light from the light-emitting diodes 9 directed into it. A reflective sheet 12 is disposed on the side of the light guiding plate 10 that faces away (side that faces outwardly) from the liquid crystal panel 2. In addition, lens sheets, diffuser sheets, and other optical sheets 13 are provided on the side of the light guiding plate 10 facing the liquid crystal panel 2 (light-emitting side), and light from the light-emitting diodes 9, which is guided in a predetermined light-guiding direction (from left to right in FIG. 1) into the light guiding plate 10, is transformed into the above-mentioned planar illumination light of uniform brightness and supplied to the liquid crystal panel 2.

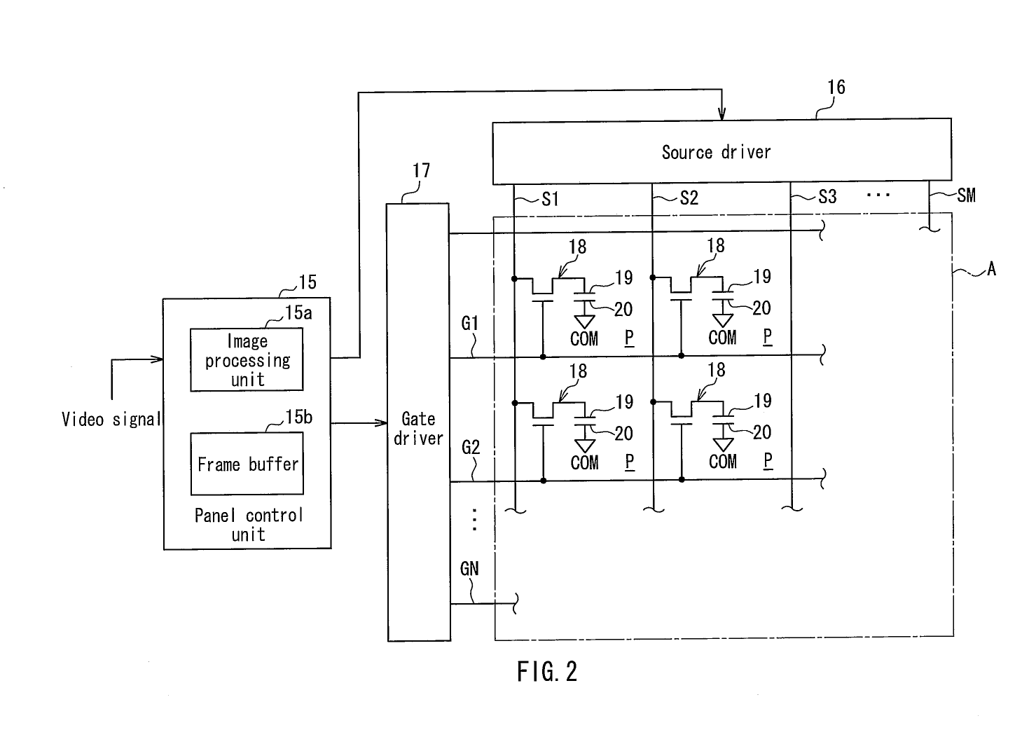

Next, the liquid crystal panel 2 of the present embodiment will be specifically described with reference to FIG. 2.

FIG. 2 is a diagram depicting the configuration of the liquid crystal panel illustrated in FIG. 1.

In FIG. 2, a panel control unit 15, which controls the actuation of the liquid crystal panel 2 (FIG. 1) serving as the above-described display unit used for displaying information such as text, images, and the like, and a gate driver 17 and a source driver 16, which operate based on instruction signals received from this panel control unit 15, are provided in the liquid crystal display device 1 (FIG. 1).

The panel control unit 15, which is provided in the above-mentioned control device, receives a video signal from outside the liquid crystal display device 1. In addition, the panel control unit 15 includes an image processing unit 15a, which generates instruction signals for the source driver 16 and the gate driver 17 by performing predetermined image processing on the received video signal, and a frame buffer 15b, which can store display data for a single frame contained in the received video signal. In addition, the panel control unit 15 controls the actuation of the source driver 16 and the gate driver 17 in response to the received video signal, as a result of which information corresponding to the video signal is displayed on the liquid crystal panel 2.

The source driver 16 and the gate driver 17 are disposed on the active-matrix substrate 5. More specifically, the source driver 16 is disposed on the surface of the active matrix substrate 5 in the horizontal direction of the liquid crystal panel 2 in a region located outside of the effective display area A of the liquid crystal panel 2 used as a display panel. Additionally, the gate driver 17 is disposed on the surface of the active matrix substrate 5 in the vertical direction of the liquid crystal panel 2 in a region located outside of the above-described effective display area A.

Additionally, the source driver 16 and the gate driver 17 are drive circuits driving multiple pixels P provided on the liquid crystal panel 2 on a pixel-by-pixel basis, with multiple source lines S1-SM (where M is an integer of 2 or more, hereinafter collectively referred to as “5”) and multiple gate lines G1-GN (where N is an integer of 2 or more, hereinafter collectively referred to as “G”) respectively connected to the source driver 16 and the gate driver 17. These source lines S and gate lines G, which respectively constitute data lines and scanning lines, are arranged in a matrix-like configuration. Namely, the source lines S are provided such that they are parallel to the column direction of the matrix (vertical direction of liquid crystal panel 2) and the gate lines G are provided such that they are parallel to the row direction (horizontal direction of liquid crystal panel 2) of the matrix.

Additionally, switching elements 18, which are constituted, for example, by thin film transistors (Thin Film Transistors), and the above-described pixels P, which a have pixel electrode 19 connected to a switching element 18, are provided in the vicinity of the intersections between these source lines S and gate lines G. Further, in each pixel P, a common electrode 20 is formed facing the pixel electrode 19, such that the above-mentioned liquid crystal layer provided in the liquid crystal panel 2 is sandwiched therebetween. In other words, in the active matrix substrate 5, the switching elements 18, pixel electrodes 19, and common electrodes 20 are provided on a pixel-by-pixel basis.

Further, regions constituting multiple pixels P are formed on the active matrix substrate 5 in regions produced as a result of partitioning in a matrix-like manner by the source lines S and the gate lines G. These multiple pixels P include red (R), green (G), and blue (B) pixels. In addition, these RGB pixels are arranged sequentially, for instance, in the above-mentioned order, in parallel to the gate wiring lines G1-GN. Furthermore, these RGB pixels are designed to be capable of displaying the corresponding colors with the help of a color filter layer (not shown) provided on the color filter substrate 4.

In addition, in response to instruction signals from the image processing unit 15a, the gate driver 17 on the active matrix substrate 5 sequentially outputs scanning signals (gate signals) that turn the gate electrodes of the corresponding switching elements 18 on for the lines G1-GN. In addition, in response to instruction signals from the image processing unit 15a, the source driver 16 outputs data signals (voltage signals (gray scale voltage)) corresponding to the brightness (gray scale) of the displayed images to the corresponding source lines S1-SM.

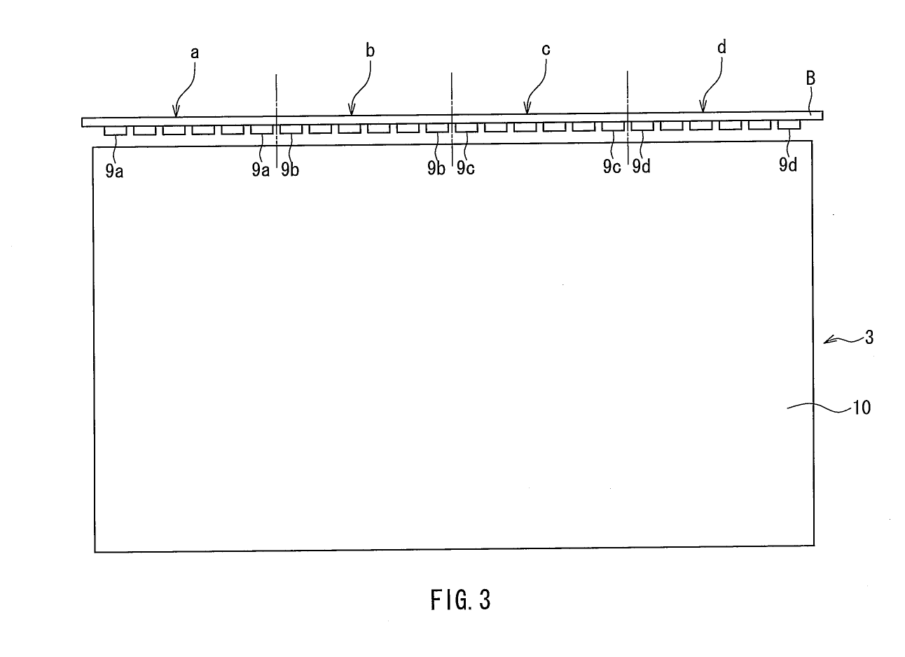

Next, the configuration of the main components of the lighting device 3 of the present embodiment will be specifically described with reference to FIG. 3-FIG. 5.

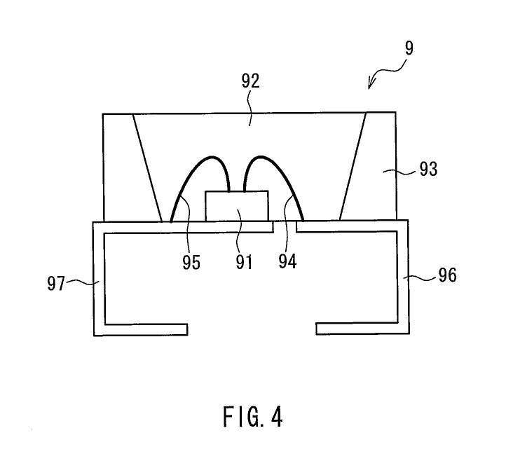

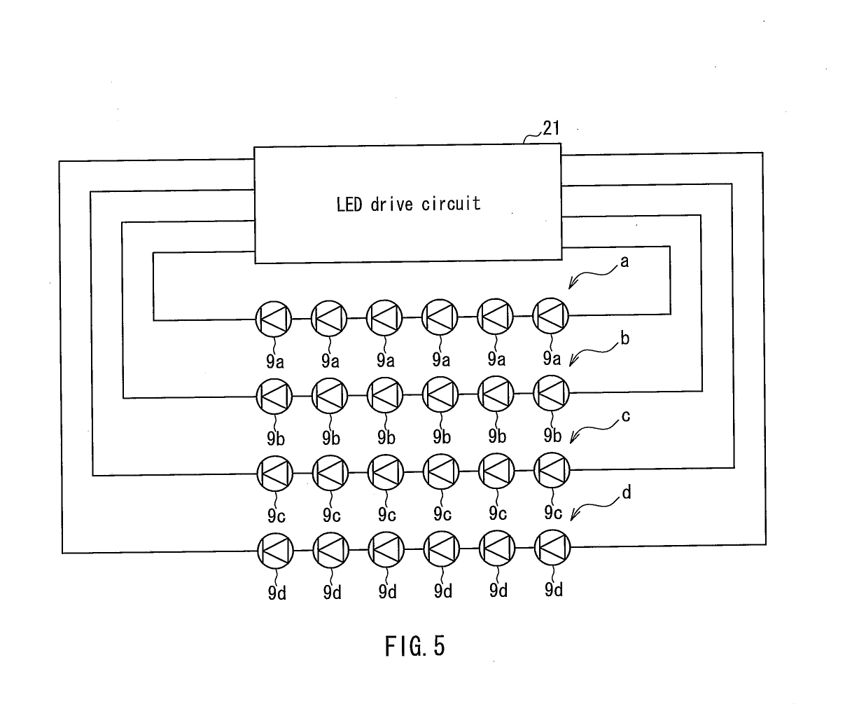

FIG. 3 is a plan view illustrating the configuration of the main components of the above-described lighting device. FIG. 4 is a diagram depicting the configuration of the main components of the light-emitting diode illustrated in FIG. 1. FIG. 5 is a circuit schematic illustrating a drive circuit used in the above-described light-emitting diode.

As shown in FIG. 3, the lighting device 3 is provided with multiple, e.g. 24, light-emitting diodes 9a, 9b, 9c, and 9d (hereinafter collectively referred to as “9”). These light-emitting diodes 9 are arranged on an LED substrate B in a rectilinear fashion. In addition, as demarcated by the dashed lines in FIG. 3, the light-emitting diodes 9 are divided into four blocks a, b, c, d, each including 6 light-emitting diodes 9, in the direction of arrangement on the LED substrate B (in the horizontal direction in FIG. 3). Namely, six light-emitting diodes 9a are contained in block a, and six light-emitting diodes 9b are contained in block b. In addition, six light-emitting diodes 9c are contained in block c, and six light-emitting diodes 9d are contained in block d.

In addition, among these each blocks a-d, the corresponding six light-emitting diodes 9a-9d are connected in series and adapted to be supplied with different supply current values (as discussed in more detail below).

In addition, (pseudo) white light-emitting diodes are used as the light-emitting diodes 9 to inject white light inside the light guiding plate 10. In addition, as shown in FIG. 4, these light-emitting diodes 9 are provided with a semiconductor element 91 serving as a luminous element radiating light in a predetermined wavelength range and are adapted to outwardly emit white light. In other words, the light-emitting diodes 9 are provided with a semiconductor element 91, which radiates light, e.g. blue light, and encapsulating resin 92, which encapsulates the semiconductor element 91 by filling the inside of an enclosing member 93 that encloses the semiconductor element 91. In addition, the light-emitting diodes 9 are provided with fine lead lines 94, 95 connected to the semiconductor element 91 inside the enclosing member 93, and leads 96, 97 respectively connected to the fine lead lines 94, 95 on the outside of the enclosing member 93.

In addition, as shown in FIG. 5, an LED drive circuit 21 supplying electric current to the plurality of block units is connected to the light-emitting diodes 9. Specifically, in each of the blocks a-d, as described above, the six corresponding light-emitting diodes 9a-9d are connected in series. In addition, the light-emitting diodes 9a-9d respectively included in the blocks a-d are connected in parallel to the LED drive circuit 21, and the LED drive circuit 21 is adapted to be able to change the values of the supplied electric current for each of the block units and supply it thereto.

In addition, the LED drive circuit 21 is adapted to drive the light-emitting diodes 9 for illumination, e.g. using current-controlled illumination. In addition, the LED drive circuit 21 is adapted to drive these light-emitting diodes 9a-9d for illumination by making the values of the electric current supplied to the light-emitting diodes 9b, 9c contained in the central blocks b, c in the above-mentioned direction of arrangement lower than the values of the electric current supplied to the light-emitting diodes 9a, 9d contained in the blocks a, d located on the outside of the central blocks b, c.

Specifically, the LED drive circuit 21 is adapted to supply, for example, a forward current of 80 mA to the light-emitting diodes 9a, 9d contained in the external blocks a, d when it supplies, e.g. a forward current of 40 mA to the light-emitting diodes 9b, 9c contained in the central blocks b, c. In addition, these supply current values are established by measuring the temperature distribution obtained when driving the light-emitting diodes 9 for illumination in advance and using the measured temperature distribution.

It should be noted that, in addition to the description above, the LED drive circuit 21 may be adapted to drive the light-emitting diodes 9 for illumination using PWM dimming.

In the lighting device 3 of the present embodiment configured as described above, the plurality of light-emitting diodes 9, which are rectilinearly arranged, are divided into the plurality of blocks a-d in the direction of their arrangement. In addition, among the plurality of blocks a-d, the values of the electric current supplied to the light-emitting diodes 9b, 9c contained in the central blocks b, c in the direction of arrangement are made lower than the values of the electric current supplied to the light-emitting diodes 9a, 9d contained in the blocks a, d located on the outside of the central blocks b, c. This makes it possible to achieve a uniform temperature distribution across the plurality of light-emitting diodes 9 in the lighting device 3 of the present embodiment. As a result, in contradistinction to the above-described conventional example, in the present embodiment, the installation of thermal dissipating structure such as thermal dissipating member and the like can be forgone and a reduction in the size of the lighting device 3 can be achieved even if the number of installed light-emitting diode 9 is increased. Namely, the present embodiment makes it possible to easily produce a lighting device 3 of reduced thickness and, as a consequence, a liquid crystal display device 1 of reduced thickness.

In addition, in the present embodiment, the values of the electric current supplied to the light-emitting diodes 9a, 9d contained in the external blocks a, d can be made higher than the values of the electric current supplied to the light-emitting diodes 9b, 9c contained in the central blocks b, c, which makes it possible to easily form a high-intensity lighting device 3.

In addition, in the present embodiment, a uniform temperature distribution can be achieved across the plurality of light-emitting diodes 9, which makes it possible to easily form a durable lighting device 3. Namely, for example, if the values of the electric current supplied to the light-emitting diodes 9b, 9c contained in the central blocks b, c are set to be identical to the values of the electric current supplied to the light-emitting diodes 9a, 9d contained in the external blocks a, d, then the light-emitting diodes 9b, 9c will be subject to the effects of heat buildup in the adjoining light-emitting diodes 9a, 9d and their ambient temperature will exceed the ambient temperature of the light-emitting diodes 9a, 9d. Thus, when the light-emitting diodes 9b, 9c are in a high-temperature environment, the useful life of the light-emitting diodes 9b, 9c is subject to degradation in comparison with the light-emitting diodes 9a, 9d. By contrast, in the present embodiment, the temperature distribution across the light-emitting diodes 9a-9d is homogenized, thereby preventing the light-emitting diodes 9b, 9c from being placed in a high-temperature environment, and these light-emitting diodes 9b, 9c can be prevented from useful life degradation in comparison with the light-emitting diodes 9a, 9d.

In addition, in the lighting device 3 of the present embodiment, the temperature distribution obtained in the plurality of light-emitting diodes 9 when they are driven for illumination is measured in advance and, in the multiple blocks a-d, the values of the electric current supplied to these light-emitting diodes 9a-9d are established using the measured temperature distribution. As a result, in the lighting device 3 of the present embodiment, the values of the electric current supplied to the light-emitting diodes 9a-9d each of the plurality of blocks a-d can be established in a more adequate manner and a uniform temperature distribution across the plurality of light-emitting diodes 9 can be achieved in a more reliable manner.

In addition, in the lighting device 3 of the present embodiment, the electric current can be supplied to the light-emitting diodes 9a-9d of the above-mentioned plurality of blocks a-d in an adequate manner because the device is provided with the LED drive circuit 21, which supplies electric current to the plurality of light-emitting diodes 9 in the plurality of block units.

In addition, in the present embodiment, a high-brightness and compact liquid crystal display device (display device) 1 can be built easily because lighting devices 3 can be used that are capable of achieving a reduction in size even when the number of installed light-emitting diode 9 is increased.

It should be noted that all of the embodiments described above are merely illustrative, and not restrictive. The technical scope of the present invention is defined by the claims and all modifications that come within the range of equivalency of the configurations described herein are also included in the technical scope of the present invention.

For example, while in the description above the present invention was discussed using examples, in which it was applied to a transmissive-type liquid crystal display device, the lighting device of the present invention is not limited thereto and can be applied to various display devices equipped with non-emissive display units displaying images, text, and other information with the help of light from light-emitting diodes. Specifically, the inventive lighting device can be advantageously employed in transflective-type liquid crystal display devices, or in projection-type display devices, in which liquid crystal panels are used as light valves.

In addition, in the description above, the 24 light-emitting diodes were arranged in a rectilinear manner and these light-emitting diodes were divided into four blocks. In addition, it was explained that among the four blocks, the values of the electric current supplied to the six light-emitting diodes contained in each of the two central blocks were made lower than the values of the electric current supplied to the six light-emitting diodes contained in each of the blocks on the right and left. However, the inventive lighting device is not limited in any way with regard to the number of installed light-emitting diode, the number of configured block, the number of included light-emitting diode, and the like as long as in the lighting device, which has the plurality of light-emitting diodes arranged in a rectilinear fashion, the plurality of light-emitting diodes are divided into the plurality of blocks in the direction of their arrangement and the values of the electric current supplied to the light-emitting diodes contained in the central blocks in the direction of arrangement are made lower than the values of the electric current supplied to the light-emitting diodes contained in the blocks located on the outside of the central blocks.

In addition, although the description above discussed configuring two types of values of the electric current supplied to the light-emitting diodes, the inventive lighting device is not limited thereto and may be adapted to configure three or more types of supply current values. Thus, among the plurality of blocks, the values of the electric current supplied to the light-emitting diodes are set such that they become progressively lower from the external blocks towards the central blocks in the direction of arrangement. As a result, a uniform temperature distribution can be obtained in a reliable manner even when three or more blocks with different supply current values are provided.

In addition, while the description above discussed using an edge-lit lighting device equipped with a light guiding plate, the inventive lighting device is not limited thereto, and it is also possible to use, for example, a direct-lit lighting device, in which there is at least one group of multiple light-emitting diodes arranged in a rectilinear manner on the non-viewing side of a liquid crystal panel.

In addition, although the description above discussed using (pseudo) white light-emitting diodes, the inventive light-emitting diodes are not limited thereto and may use, for example, RGB light-emitting diodes respectively radiating red (R), green (G), and blue (B) light, or use light-emitting diodes of the 3-in-1 type produced by integrating RGB light-emitting diodes in one body.

However, the use of identical light-emitting diodes radiating white light as the plurality of light-emitting diodes in the manner shown in the above-described embodiment is preferable from the standpoint of facilitating control over the driving of the luminaire for illumination in comparison with using light-emitting diodes of multiple types.

### INDUSTRIAL APPLICABILITY

The present invention is useful as a lighting device, as well as a display device utilizing the lighting device, that is capable of achieving a reduction in size even if the number of installed light-emitting diode is increased.

### LIST OF REFERENCE NUMERALS

1 Liquid crystal display device (display device)
3 Lighting device
9a, 9b, 9c, 9d Light-emitting diode
21 LED drive circuit
a, b, c, d Block

1. A lighting device having a plurality of light-emitting diodes arranged in a rectilinear fashion,
wherein the plurality of light-emitting diodes is divided into a plurality of blocks in the direction of arrangement thereof, and
in the plurality of blocks, the values of the electric current supplied to the light-emitting diodes contained in the central blocks in the direction of arrangement are made lower than the values of the electric current supplied to the light-emitting diodes contained in the blocks located on the outside of the central blocks.

2. The lighting device according to claim 1,
wherein, in the plurality of blocks, the values of the electric current supplied to the light-emitting diodes are set so as to become progressively lower from the external blocks towards the central blocks in the direction of arrangement.

3. The lighting device according to claim 1,
wherein the temperature distribution obtained in the plurality of light-emitting diodes when they are driven for illumination is measured in advance, and
in the plurality of blocks, the values of the electric current supplied to these light-emitting diodes are established using the measured temperature distribution.

4. The lighting device according to claim 1, wherein the plurality of light-emitting diodes is provided with an LED drive circuit supplying electric current to the plurality of block units.

5. The lighting device according to claim 1, wherein identical light-emitting diodes radiating white light are used as the plurality of light-emitting diodes.

6. A display device utilizing the lighting device according to claim 1.
